(19) United States
(12) Patent Application Publication
(10) Pub. No.: US 2024/0065258 A1
(43) Pub. Date: Feb. 29, 2024

(54) Animal Deterrent Device

(71) Applicant: Jose Hernandez, Missouri City, TX (US)

(72) Inventor: Jose Hernandez, Missouri City, TX (US)

(21) Appl. No.: 18/454,145

(22) Filed: Aug. 23, 2023

Related U.S. Application Data
(60) Provisional application No. 63/400,437, filed on Aug. 24, 2022.

(51) Int. Cl. A01M 29/24; A01M 29/10; A01M 29/16; F41H 13/00

(52) U.S. Cl. CPC A01M 29/24; A01M 29/10; A01M 29/16; F41H 13/0025

(57) ABSTRACT

The present invention relates to an animal deterrent device for deterring animals while traveling outdoors on foot. The device is primarily comprised of a body having at least one handle, at least one light, at least one speaker, and at least one shocking mechanism. The device can be carried while a user is walking outdoors to protect against attacks by dogs or other animals by producing loud sounds from the speaker and flashing lights from the light. Further, the shocking mechanism can be activated by a trigger, such that a prong is propelled from the mechanism and sticks into the body of the animal, delivering an electric shock via a generator of the mechanism and a wire that is connected to the generator and the prong.

### CROSS-REFERENCE TO RELATED APPLICATION

The present application claims priority to, and the benefit of, U.S. Provisional Application No. 63/400,437, which was filed on Aug. 24, 2022, and is incorporated herein by reference in its entirety.

### FIELD OF THE INVENTION

The present invention relates generally to the field of animal deterrent and protection devices. More specifically, the present invention relates to an animal deterrent device. The device is primarily comprised of a body having at least one handle, at least one light, at least one speaker, and at least one shocking mechanism. The device can be carried while a user is walking outdoors to protect against attacks by dogs or other animals by producing loud sounds from the speaker and flashing lights from the light. Further, the shocking mechanism can be activated by a trigger such that a prong is propelled from the mechanism and sticks into the body of the animal, delivering an electric shock via a generator of the mechanism and a wire that is connected to the generator and the prong. Accordingly, the present disclosure makes specific reference thereto. Nonetheless, it is to be appreciated that aspects of the present invention are also equally applicable to other like applications, devices, and methods of manufacture.

### BACKGROUND

Many individuals travel by foot to various areas. While traveling to said areas, said individuals may encounter wild or stray animals such as, but not limited to, dogs and cats. Said individuals, especially children, may be vulnerable to attacks by stray dogs or other animals. Such attacks can cause serious injury, and even death.

Therefore, there exists a long-felt need in the art for a self-protection device. More specifically, there exists a long-felt need in the art for an animal deterrent device that can be used to protect a user against an animal attack while traveling outdoors. There also exists a long-felt need in the art for an animal deterrent device that allows a user to immobilize an attacking animal. Further, there exists a long-felt need in the art for an animal deterrent device that allows a user to immobilize and/or deter an attacking animal without the use of lethal force.

The subject matter disclosed and claimed herein, in one embodiment thereof, comprises an animal deterrent device. The device is primarily comprised of a body having at least one handle, at least one light, at least one speaker, and at least one shocking mechanism. The device can be carried while a user is walking outdoors to protect against attacks by dogs or other animals. The speaker of the device can be activated by a trigger such that the speaker produces a loud sound to scare away an animal. The light can also be activated by a trigger to produce a flash, strobing, blinking, etc., light to disorient the animal. Further, the shocking mechanism can be activated by a trigger such that a prong is propelled from the mechanism and sticks into the body of the animal, delivering an electric shock via a generator of the mechanism and a wire that is connected to the generator and the prong.

In this manner, the animal deterrent device of the present invention accomplishes all the foregoing objectives and provides a device that can be used to protect a user against an animal attack while traveling outdoors. To do so, the device allows a user to immobilize an attacking animal. Further, the device allows a user to immobilize and/or deter an attacking animal without the use of lethal force.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal deterrent device primarily comprised of a body having at least one handle, at least one light, at least one speaker, and at least one shocking mechanism. The body may have a plurality of shapes in differing embodiments but is preferably generally square in shape.

In one embodiment, the body is comprised of at least one eyelet that allows at least one strap to attach to the body. The strap may be of a fixed length or an adjustable length. The strap allows the device to be carried or slung over a shoulder/body of a user.

In another embodiment, the body may be additionally or alternatively comprised of at least one handle that allows the device to be carried. In one embodiment, the handle is comprised of at least one grip area. The handle may be secured to the body when not in use via at least one locking mechanism.

The device is also comprised of at least one light source. The light may illuminate any color known in the art and may also flash, strobe, blink, etc., in various patterns that can be controlled by at least one button. The device is also comprised of at least one speaker. The speaker produces a loud sound when activated. The sound may include, but is not limited to, thunder, fireworks, a dog whistle, etc., or any other sound that may deter a dog or other animal. The activation of the light and speaker can be controlled by at least one first trigger found on the handle and/or body. The trigger may be protected by at least one trigger guard.

The device is also comprised of at least one shocking mechanism that allows the device to deliver a shock to an attacking dog or another animal. In the preferred embodiment, the mechanism is comprised of at least one wire that delivers an electric current created by at least one generator to at least one prong that can be shot from the device once the mechanism is activated by at least one second trigger on the handle. Once deployed, the prong sticks into the skin of the dog or other attacking animal and delivers an electric current to the dog to deter and/or immobilize the dog.

The device is also comprised of a method of use. First, the first trigger can be depressed to activate the light and/or the speaker, such that a flashing effect and/or loud sound is emitted Then, the shocking mechanism can be pointed toward an attacking dog or other animal and the second trigger can be depressed to activate the shocking mechanism. This causes at least one prong to shoot outward from the mechanism into the dog, such that an electrical shock is delivered to the dog to immobilize it.

Accordingly, the animal deterrent device of the present invention is particularly advantageous as it provides a device that can be used to protect a user against an animal attack while traveling outdoors. The device allows a user to immobilize and/or deter an attacking animal without the use of lethal force. In this manner, the animal deterrent device offers an adequate means of protection.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an animal deterrent device of the present invention in accordance with the disclosed architecture;

FIG. 2 illustrates a perspective view of one potential embodiment of an animal deterrent device of the present invention while being used on a dog in accordance with the disclosed architecture; and

FIG. 3 illustrates a perspective view of one potential embodiment of an animal deterrent device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a self-protection device. More specifically, there exists a long-felt need in the art for an animal deterrent device that can be used to protect a user against an animal attack while traveling outdoors. There also exists a long-felt need in the art for an animal deterrent device that allows a user to immobilize an attacking animal. Further, there exists a long-felt need in the art for an animal deterrent device that allows a user to immobilize and/or deter an attacking animal without the use of lethal force.

The present invention, in one exemplary embodiment, is comprised of an animal deterrent device. The device is primarily comprised of a body having at least one handle, at least one light, at least one speaker, and at least one shocking mechanism. The body may have a plurality of shapes in differing embodiments but is preferably generally square in shape.

In one embodiment, the body is comprised of at least one eyelet. The eyelet allows at least one strap to attach to the body, wherein the strap may be of a fixed length or an adjustable length. The strap allows the device to be carried or slung over a shoulder/body of a user.

In a further embodiment, the body may be additionally or alternatively comprised of at least one handle. The handle allows the device to be carried. The handle may be comprised of at least one grip area. The handle can be secured to the body when not in use via at least one locking mechanism.

The device is also comprised of at least one light source that may illuminate any color known in the art and may also flash, strobe, blink, etc., in various patterns that can be controlled by at least one button. The device is also comprised of at least one speaker that produces a loud sound when activated. The sound may include, but is not limited to, thunder, fireworks, a dog whistle, etc., or any other sound that may deter a dog or other animal. The activation of the light and speaker can be controlled by at least one first trigger found on the handle and/or body. The trigger may be protected by at least one trigger guard.

The device also has at least one shocking mechanism. The mechanism allows the device to deliver a shock to an attacking dog or another animal. In the preferred embodiment, the mechanism is comprised of at least one wire that delivers an electric current created by at least one generator to at least one prong that can be shot from the device once the mechanism is activated by at least one second trigger on the handle. Once deployed, the prong sticks into the skin of the dog or other attacking animal and delivers an electric current to the dog to deter and/or immobilize the dog.

The device is also comprised of a method of use. First, the first trigger can be depressed to activate the light and/or the speaker, such that a flashing effect and/or loud sound is emitted Then, the shocking mechanism can be pointed toward an attacking dog or other animal and the second trigger can be depressed to activate the shocking mechanism. This causes at least one prong to shoot outward from the mechanism into the dog, such that an electrical shock is delivered to the dog to immobilize it.

Accordingly, the animal deterrent device of the present invention is particularly advantageous as it provides a device that can be used to protect a user against an animal attack while traveling outdoors. The device allows a user to immobilize and/or deter an attacking animal without the use of lethal force. In this manner, the animal deterrent device offers an adequate means of protection.

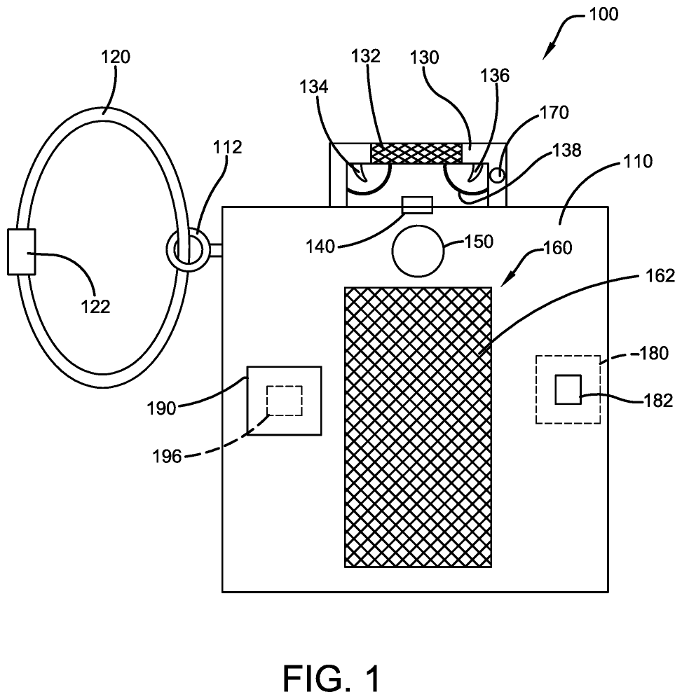

Referring initially to the drawings, FIG. 1 illustrates a perspective view of one potential embodiment of an animal deterrent device 100 of the present invention in accordance with the disclosed architecture. The device 100 is primarily comprised of a body 110 having at least one handle 130, at least one light 150, at least one speaker 160, and at least one shocking mechanism 190. The body 110 may be made of any combination of lightweight metal and/or plastic. The metal may be a durable metal such as, but not limited to, stainless steel or aluminum. The plastic may be acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The body 110 is preferably waterproof and/or water-resistant such that it can be used in the rain.

The body 110 may have a plurality of shapes in differing embodiments. In one embodiment, the body 110 is generally square in shape. However, the body 110 may be any shape such as, but not limited to, circular, rectangular, triangular, etc. In addition, the body 110 may resemble any item known in the art such that it appears inconspicuous. Said items include but are not limited to a tote bag, a messenger bag, a backpack, a purse, a wallet, a crossbody bag, etc.

In one embodiment, the body 110 is comprised of at least one eyelet 112. The eyelet 112 allows at least one strap 120 to attach to the body 110. In one embodiment, the strap 120 is of a fixed length. In another embodiment, the strap 120 is length-adjustable via at least one strap fastener 122 such as, but not limited to, a sliding buckle. The strap 120 allows the device 100 to be carried or slung over a shoulder/body of a user.

In another embodiment, the body 110 may be additionally or alternatively comprised of at least one handle 130. The handle 130 may be a fixed or a foldable handle 130. The handle 130 allows the device 100 to be carried. In one embodiment, the handle 130 is comprised of at least one grip area 132. The grip area 132 may be textured with a recessed or raised texture or may be non-textured. The grip area 132 is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc. The handle 130 may be secured to the body 110 when not in use via at least one locking mechanism 140. The locking mechanism 140 may be any mechanism such as, but not limited to, a lock, a latch, a clasp, a magnet, etc.

The device 100 is also comprised of at least one light source 150. The light source 150 may be any light-type known in the art such as, but not limited to, LED light, LCD light, fluorescent light, white light, spotlight, area light, fiber optic illuminator, incandescent, halogen, etc. The light 150 may illuminate any color known in the art. The light 150 may also flash, strobe, blink, continuously illuminate, etc., in various patterns that can be controlled by at least one button 180.

In addition, the device 100 is comprised of at least one speaker 160. The speaker 160 may be any speaker type known in the art. The speaker 160 is preferably waterproof. The speaker 160 may also be protected by at least one grille 162 made of a plastic and/or metal material. The speaker 160 produces a loud sound when activated. The sound may be continuous or intermittent. The sound may include, but is not limited to, thunder, fireworks, a dog whistle, etc., or any other sound that may deter a dog or other animal.

The activation of the light 150 and speaker 160 can be controlled by at least one first trigger 134 found on the handle 130 and/or body 110. The trigger 134 may be protected by at least one trigger guard 138. In one embodiment, pressing the trigger 134 multiple times may allow a user to cycle through functions of the light 150 and/or speaker 160.

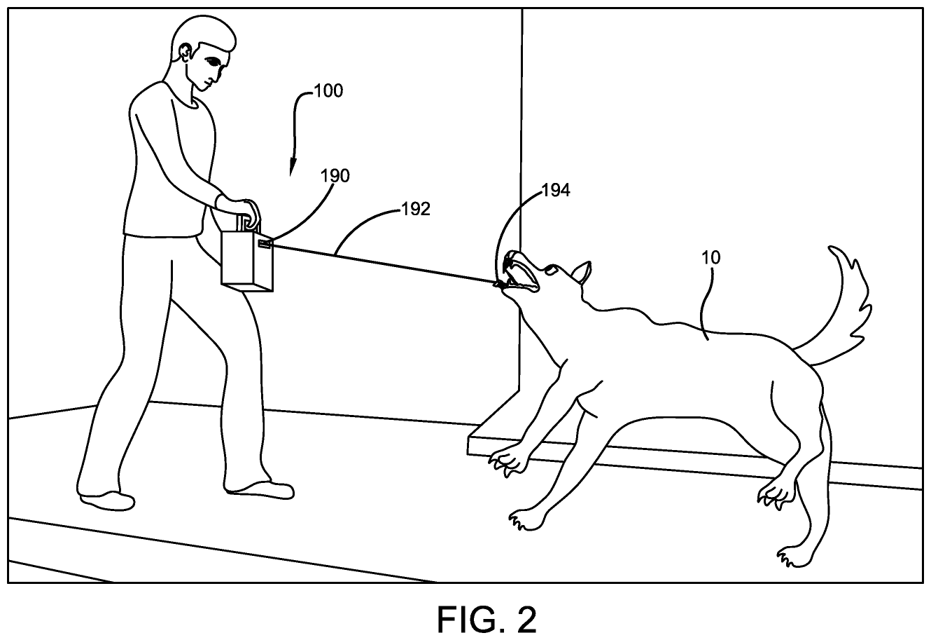

FIG. 2 illustrates a perspective view of one potential embodiment of an animal deterrent device 100 of the present invention while being used on a dog 10 in accordance with the disclosed architecture. The device 100 is also comprised of at least one shocking mechanism 190. The mechanism 190 allows the device 100 to deliver a shock to an attacking dog or another animal. In the preferred embodiment, the mechanism 190 is comprised of at least one wire 192 that delivers an electric current created by at least one generator 196 to at least one prong 194 (of any type known in the art) that can be shot from the device 100. The mechanism 190 is activated by at least one second trigger 136 on the handle 130 that may be protected by at least one trigger guard 138. Once deployed, the prong 194 sticks into the skin of the dog or other attacking animal and delivers an electric current to the dog to deter and/or immobilize the dog.

The prongs 194 may be deployed by a gas, electric mechanism, or another propellant mechanism 198. In one embodiment, the prongs 194 are deployed by compressed nitrogen. The mechanism 190 may deliver a shock for the entire time the trigger 136 is pulled or for a finite amount of time.

The speaker 160, light 150, and shocking mechanism 190 are powered by at least one battery 180. The battery 180 may be a disposable battery 180 or a rechargeable battery 180 in the form of an alkaline, nickel-cadmium, nickel-metal hydride battery 180, etc., such as any 3V-12 volts DC battery 180 or other conventional battery 180 such as A, AA, AAA, etc., that supplies power to the device 100. Throughout this specification, the terms “battery” and “batteries” may be used interchangeably to refer to one or more wet or dry cells or batteries 180 of cells in which chemical energy is converted into electricity and used as a source of DC power. References to recharging or replacing batteries 180 may refer to recharging or replacing individual cells, individual batteries 180 of cells, or a package of multiple battery cells as is appropriate for any given battery 180 technology that may be used. Additionally, the battery 150 may be recharged by a USB port 182 of any type known in the art. In another embodiment, the animal deterrent device 100 may be in wireless communication with a mobile application on a smart phone.

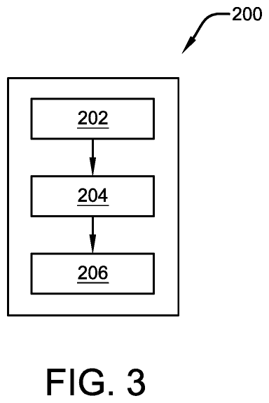

FIG. 3 illustrates a perspective view of one potential embodiment of an animal deterrent device 100 of the present invention in accordance with the disclosed architecture. The device 100 is also comprised of a method of use 200. First, the first trigger 134 can be depressed to activate the light 150 and/or the speaker 160, such that a flashing effect and/or loud sound is emitted [Step 202]. Then, the shocking mechanism 190 can be pointed toward an attacking dog 10 or another animal [Step 204]. Next, the second trigger 136 can be depressed to activate the shocking mechanism 190, causing at least one prong 194 to shoot outward from the mechanism 190 into the dog 10 such that an electrical shock is delivered to the dog 10 to immobilize the dog 10 [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “animal deterrent device” and “device” are interchangeable and refer to the animal deterrent device 100 of the present invention.

Notwithstanding the foregoing, the animal deterrent device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the animal deterrent device 100 as shown in the FIGS. are for illustrative purposes only, and that many other sizes and shapes of the animal deterrent device 100 are well within the scope of the present disclosure. Although the dimensions of the animal deterrent device 100 are important design parameters for user convenience, the animal deterrent device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal deterrent device comprising:
a body;
a trigger;
a speaker;
a battery;
a light; and
a shocking mechanism.

2. The animal deterrent device of claim 1, wherein the speaker produces a sound.

3. The animal deterrent device of claim 2, wherein the sound is comprised of a thunder sound or a firework sound.

4. The animal deterrent device of claim 1, wherein the light is comprised of an LED light.

5. The animal deterrent device of claim 4, wherein the LED light can flash, strobe, blink or continuously illuminate.

6. An animal deterrent device comprising:
a body;
a first trigger;
a second trigger;
a battery;
a speaker;
a light; and
a shocking mechanism comprised of a wire, a prong and a generator.

7. The animal deterrent device of claim 6, wherein the first trigger activates the light.

8. The animal deterrent device of claim 6, wherein the first trigger activates the speaker.

9. The animal deterrent device of claim 6, wherein the second trigger activates the shocking mechanism.

10. The animal deterrent device of claim 6, wherein the generator produces an electric current.

11. An animal deterrent device comprising:
a body;
a first trigger;
a second trigger;
a trigger guard;
a battery;
a speaker;
a light; and
a shocking mechanism comprised of a wire, a prong and a generator.

12. The animal deterrent device of claim 11, wherein the prong is propelled from the shocking mechanism by a propellant mechanism.

13. The animal deterrent device of claim 12, wherein the propellant mechanism is comprised of a gas.

14. The animal deterrent device of claim 11, wherein the first trigger and the second trigger are positioned on the handle.

15. The animal deterrent device of claim 11, wherein the body is comprised of a tote bag, a messenger bag, a backpack, a purse, a wallet, or a crossbody bag shape.

16. The animal deterrent device of claim 11, wherein the speaker produces a dog whistle.

17. The animal deterrent device of claim 11, wherein the wire places the prong in electrical communication with the generator.

18. The animal deterrent device of claim 11, wherein the generator produces a continuous electric current or a non-continuous electric current.

19. The animal deterrent device of claim 11, wherein the battery is comprised of a charging port.

20. The animal deterrent device of claim 11, wherein the handle is comprised of a locking mechanism that secures the handle to the body.
